(19) United States
(12) Patent Application Publication
(10) Pub. No.: US 2016/0025284 A1
(43) Pub. Date: Jan. 28, 2016

(54) SAFETY LIGHT DEVICE

(71) Applicant: Dan Inman, West Lake Hills, TX (US)

(72) Inventor: Dan Inman, West Lake Hills, TX (US)

(21) Appl. No.: 14/809,874

(22) Filed: Jul. 27, 2015

Related U.S. Application Data
(60) Provisional application No. 62/029,121, filed on Jul. 25, 2014.

(51) Int. Cl. F21S 4/00; F21V 27/00

(52) U.S. Cl. CPC F21S 4/007; F21V 27/00; F21W 2111/02

(57) ABSTRACT

Certain embodiments are directed to a safety device designed to be deployed to demarcate a location. In certain aspects the location is to be void of traffic.

This Application is a non-provisional application claiming priority to U.S. Provisional Application 62/029,121 filed Jul. 25, 2014, which is incorporated herein by reference in its entirety.

### BACKGROUND

Roads typically have stripes, raised pavement markers, rumble strips, or solid lines to demarcate traffic lanes and other boundaries. Situations do arise that necessitate re-direction of vehicular, bicycle, or pedestrian traffic out of a demarcated lane or path. Such situations occur when there is a traffic accident on the road, a disabled vehicle, during road construction or repair, and the like. In these types of situations it is necessary to direct the traffic to provide for the safety of those individuals traveling the path, working an accident, working construction, or the like.

Weighted physical barriers can enhance the safety of a road site or other path, but their weight and size makes it costly and difficult to deploy these types of barriers. Emergency personnel and road crews depend on lightweight traffic delineators such as plastic cones or barrels to visibly alert drivers to either follow a new, temporarily delineated traffic lane, or to alert drivers that they are approaching a road work site. While relatively easy to deploy the person deploying these devices is exposed to the hazard of approaching traffic. Furthermore, such lightweight visible traffic lane delineators do not enhance the physical safety of the site in that an errant vehicle straying from the proper vehicle path will drive over or knock aside such traffic lane delineators. Moreover, none of these barriers provide an advance warning capability for persons located near a site to impending danger.

There remains a need for additional devices that redirect traffic and/or demarcate a traffic free area that can reduce the risk of injury or life-threatening situations while being of a size and weight that permits easy deployment and storage of the device.

### SUMMARY

Certain embodiments are directed to a safety device designed to be deployed to demarcate a location. In certain aspects the demarcated location is to be void of traffic. In certain aspects a safety device comprises lighted elements arranged along a flexible device that is configured to be wound around and deployed from a reel, a first end of the flexible device being attached to the reel. In certain aspect the second end of the device is attached to an anchor or a vehicle or barrier. In a further aspect the reel can be configured as an anchor and the other end configured to be attached to a second attachment point.

The lighted elements can be light emitting diodes (LEDs), bulbs, or other light sources. In certain aspects the lighted elements are LEDs. The LEDs can be white, red, or any other color or produced any combinations of colors. In further aspects the lighted elements can be programmed to blink, flash, and/or change color. In certain aspects the lighted elements are coupled to a power source. The power source can be a portable power source or an established power grid. The power source can be a battery or a generator.

In certain aspects the lighted elements are wired so that damage to one element does not affect all or a portion of the other lighted elements. In certain embodiments all or a portion of the lighted elements are wired in parallel.

In certain embodiments the lighted elements are contained, embedded, or positioned inside the flexible device. The flexible device is configured to be wound, rolled, or folded into a compact shape for transport and storage without damaging the wiring or lighted elements. In particular aspects the flexible device is 5, 10, 15, 20, 25, 50, 75, 100, 125, 150, 175, or more feet long, including all values and ranges there between. The flexible device can be 0.25, 0.5, 0.75, 1, 1.25, 1.5, 1.75, 2, 2.25, 2.5, 2.75, 3, 3.25, 3.5, 3.75, 4, 4.25, 4.5, or 4.75, inches in width at its widest cross-section. The flexible device can have a cross-section shape that is substantially square, rectangular, oval, round, triangular, crescent, semi-circular, flattened crescent, trapezoidal, or ribbon-like. The flexible device can form a lumen through in which the lighted elements are positioned. Alternatively the flexible device can comprise a molded polymer in which the lighted elements are positioned during the molding process. In certain aspects a flexible device can be a flexible tubing or ribbon with a lighted element lumen. In a further aspect the flexible device is configured to be weather proof in that the lighted elements are protected from weather conditions or water that may be in the environment in which the device is deployed.

In certain aspects the flexible device is attached to at least one anchor. The anchor can be positioned at the one or both ends of the flexible device and can be used to assists in deploying and maintaining the position of the device when deployed. In certain aspects other intermediate, removable anchors can be configured to be placed along the length of the device at various intervals. In certain aspects the anchors comprise water, metal, sand, concrete, or similar weighted material to provide enough weight to immobilize at least one end or a portion of the flexible device during deployment and/or operation. The device can also be configured to be attached to other immobilized objects such as vehicles, barriers, trees, buildings, and the like. The attachments can use clips, bolts, quick release mechanism and the like to secure the flexible device during deployment and use. Attachments can be positioned at the ends of the flexible device and/or along the length of the device.

The flexible device can be part of a reel system or assembly. A reel can comprise a body and a handle. The body can comprise a base and a spool. The base comprises a frame and an axel. The spool is moveable around the axel and is configured to allow winding and unwinding of a flexible device around the spool. The frame is configured to be stationary and provide stability that allows the winding and unwinding from the spool. The frame can be a stand-alone or it can be configured to be attached an immobilized or stationary object. In certain aspects the reel is attached to or mounted on a vehicle.

In certain aspects the flexible device is associated with at least one sensor configured to detect compression of the flexible device. In certain aspects the sensors are incorporated into the flexible device at the ends or along intervals of the flexible device. The sensor is coupled to an alarm that sounds when a predetermined pressure is applied to the flexible device. This alarm can be used to alert those around the deployed device that a vehicle or something else has crossed over the device and that they may be in danger. In certain aspects a separate sensor “rope” is deployed along side or attached to the flexible device.

In certain embodiments the reel assembly, which includes the reel and the flexible device, is designed to be a stand-alone device that use the reel as one of the anchor points. In a further aspect the reel is designed to be attached to an immobile or stationary object, such as a barrier, guardrail, vehicle, post, gate support, tree, or the like. In certain aspect the vehicle is an emergency or construction vehicle.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 illustrates a longitudinal cross section of a flexible light device.

FIG. 2 illustrates cross sections along the A-A plane of FIG. 1 for various embodiments.

FIG. 3 illustrates an embodiment of the safety device deployed at an accident site.

FIG. 4 illustrates a flexible device wound on a reel.

FIG. 5 illustrates a schematic of one embodiment of a system described herein.

### DESCRIPTION

Embodiments are directed to a safety device comprising a flexible light device that can be attached to a storage reel and an anchor. In certain aspects the device is designed to be deployed for demarcating a location. In certain aspects the location is to be void of traffic.

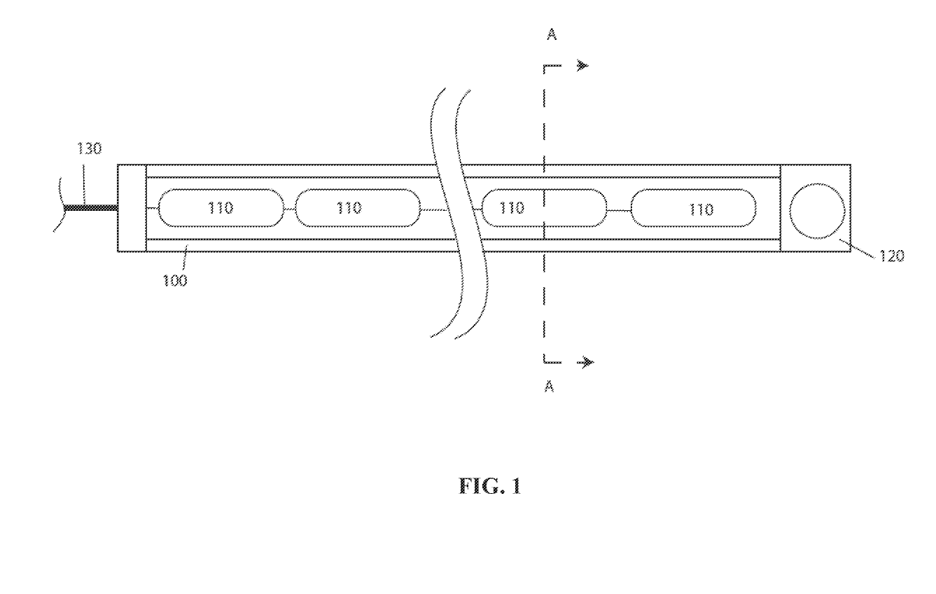

FIG. 1 illustrates one example of a lighted flexible device (light rope). An outer casing 100 forms a lumen for positioning of or is molded around light elements 110. The casing is such that light produced in the lumen is transmitted through the casing and is visible outside of the casing. In certain aspects the casing can be up to or longer than about 200 feet. The flexible device has an anchor attachment portion 120 that can be attached to an anchor for immobilizing one or both ends of the flexible device. One end has a power connection 130 that can be coupled to a power source to power light elements 110. The flexible device can be connected to a reel that can be wound or unwound to store or deploy the flexible device respectively.

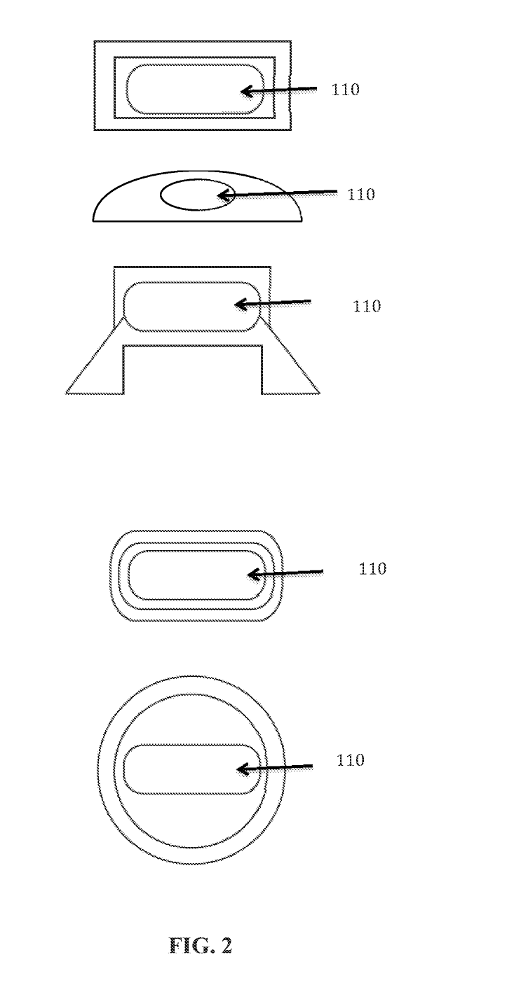

FIG. 2 illustrates examples of cross section through line A-A of FIG. 1. The casing can be a tube, ribbon or other extended shape that forms a lumen for the light elements. The casing can be configured to stack or wind so as to minimize the circumference of the wound flexible device.

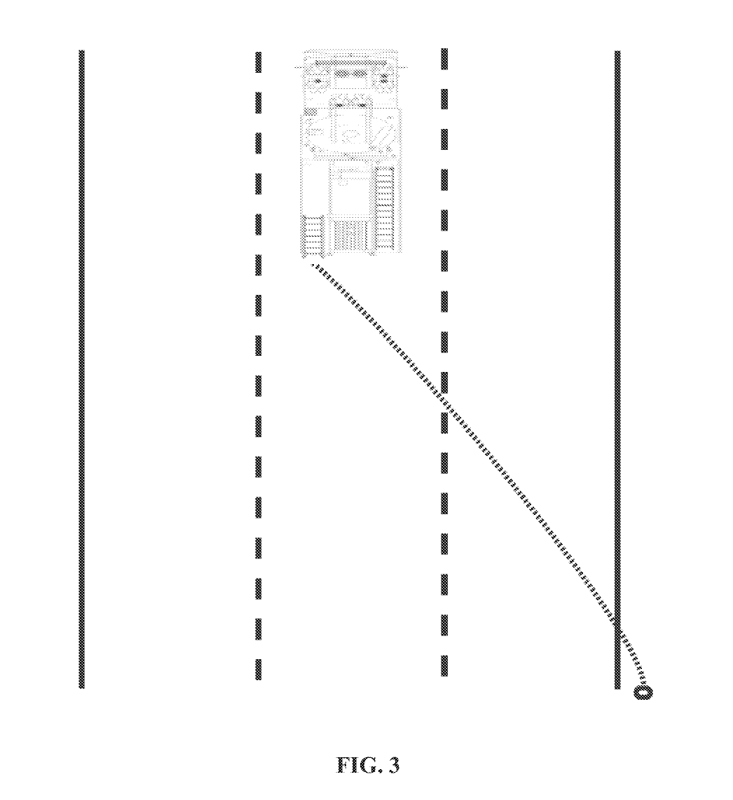

FIG. 3 illustrates an example of the flexible device deployed at an accident site. The method of deployment can include an emergency vehicle arriving at the scene and setting an anchor approximately 150 to 200 feet behind the accident (i.e., on the oncoming traffic side of the accident). Once the anchor is positioned the emergency vehicle releases the reel so that the flexible device can unwind from the reel. The emergency vehicle then moves towards the accident site unwinding the device as it moves. In certain instance the emergency vehicle will be positioned to protect the accident site with a lighted flexible device stretching in an increasing arc as it nears the site. The deployed device provides a bright visible demarcation of the site and guides oncoming traffic into a lane open to through traffic.

In certain aspects the lighted elements are light emitting diodes (LEDs). Light emitting diodes are devices that emit light by an application of an electric current across a semiconductor p-n junction. LEDs are current operated devices, not voltage operated devices. The drive current through an LED lamp must be controlled. This is typically done by placing a current limiting resistor in series with the LED lamp. The voltage drop across an LED is a function of the “drive current” through the device. An AC current source can be used to drive an LED as long as the peak current does not exceed the forward current ratings for the device. A rectifier diode should be placed in series with an LED to prevent excessive reverse biasing by the AC drive signal. The typical operating life of an LED is in excess of 100,000 hours (approximately 11 years). The operating voltage of an LED is between about 1.5 VDC and 3.5 VDC and the operating current of an LED is between about 2 and 30 ma. The operating life and the light output are a function of the LED junction temperature. Power dissipation is derated as the ambient temperature increases above a certain point, e.g., 50 degrees C. (122 degrees F.). Power derating is usually achieved by reducing the forward drive current to a level specified for safe operation at a particular ambient temperature. LED lamps are usually rated at operating temperatures from −20 degrees C. to +100 degrees C. Light elements can be LED, OLED, EL (electro-luminescent) wire (needs alternating current), FIPEL (field-induced polymer electroluminescent technology), or combinations thereof.

The lighting elements can be attached to an appropriate power source to provide for illuminating the light elements. One power source that can be used is an alternating current (AC) power source. One such mobile AC power source employs an alternator driven by the vehicle engine or any other rotational source and incorporates two stator windings and one rotor, or two stators, four windings and two rotors on a common shaft. The stator windings are insulated electrically from each other. AC output voltage is held constant by using the voltage produced by the alternator as feedback and controlling the alternator rotor current. A voltage step up circuit boosts the voltage from the alternator if it is below a threshold value as occurs at low engine RPM. A 2 quad PWM circuit encodes a low frequency sine wave onto a high frequency carrier. An output filter removes the high frequency carrier and produces a sine wave output.

Also included is electronic protection against over current, over load, short circuit and thermal over load conditions.

In certain aspects, the safety light device comprises a string of lights electrically interconnected by an electrical cord and terminated by at least one electrical connector. A plurality of lights are connected so that all lights can be illuminated and that damage to portions of the lights does not disrupt operation of the non-damaged portions.

The light elements can be position in or on a flexible device that can extend 200 feet or more and be wound, rolled, or folded for storage, until it is needed. The safety device is accommodated in a flexible, light-transmitting tube or casing that may be closed at its ends by sealing plugs or the like, one of said plugs having passages for the electrical wires such that the lighting string, fixed to a plug, is freely movable in the tube.

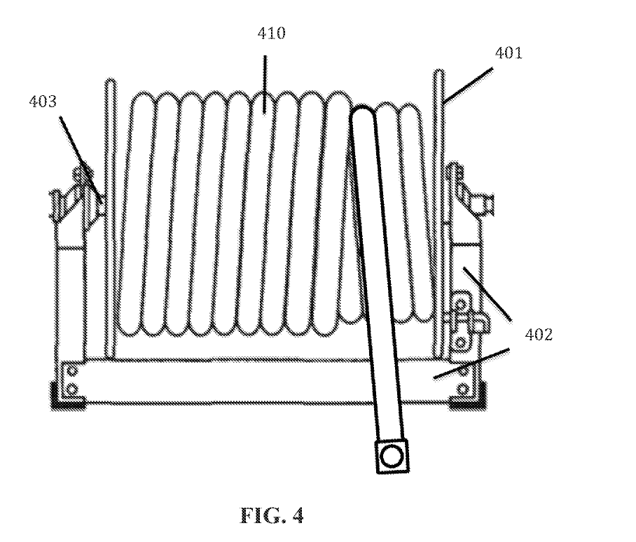

A flexible lighted device or light string can be stored on a reel. One example of a device wound on a reel is illustrated in FIG. 4. A storage reel can comprise at least one reel 401 including a center section and first and second side sections, each center section being formed in a generally cylindrical configuration with an essentially hollow interior, each side section having a hole and being affixed to the center section, the first side section including an aperture and a slot, the aperture being in communication with the hollow interior of the center section for storage of the flexible device, in an operative orientation (unwound state) a user can place a plug or wiring of a flexible device through a slot to secure it in place. The flexible device can be retracted by rotating the reel and winding the flexible device onto the reel. The reel can comprise a base and a spool. The base comprises a frame 402 and an axel 403. Spool 401 is moveable around axel 403 and is configured to allow winding and unwinding of a flexible device 410 around the spool. The frame is configured to be stationary and provide stability that allows the winding and unwinding from the spool. The frame can be a stand-alone or it can be configured to be attached an immobilized or stationary object. In certain aspects the reel is attached to or mounted on a vehicle.

In certain aspects the lights in the safety device are designed to follow a specific pattern including blinking, chasing, flashing, or alternating groups of lights. In other aspects, the lights may change color.

In certain aspects the anchor is a weighted attachment at the end of the string of lights constructed of or contains water, cement, concrete, sand, or metal.

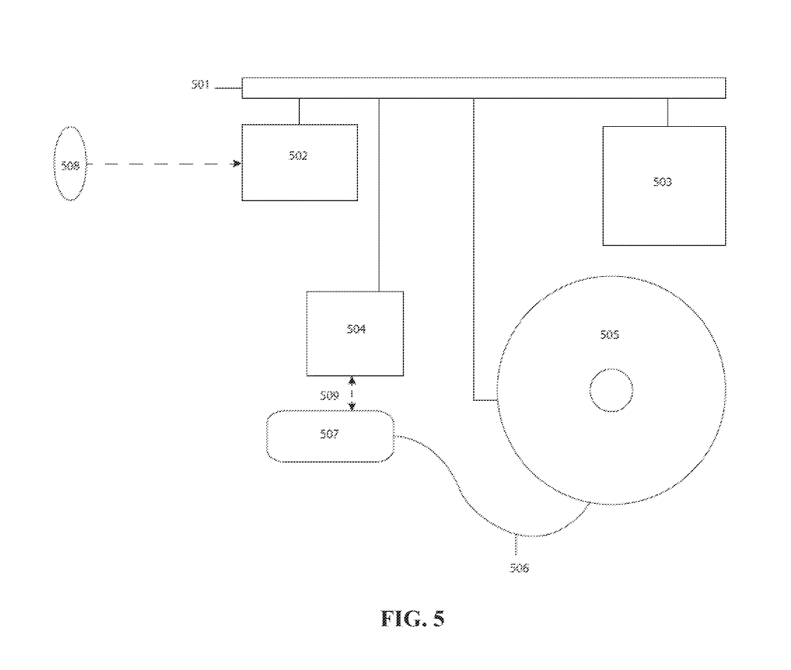

FIG. 5 illustrates a schematic of one embodiment of a lighting system. The schematic is not drawn to scale and does not represent relative dimensions of the components presented. Controller 501 is connected to a receiver 502, anchor release 504, power source 503, and reel assembly 505. Controller 501 can be wiring board or other support providing the appropriate connections between the components. Receiver 502 is configured to receive various signals from remote 508. Remote 508 is in communication with receiver 502 by wired or wireless communication. In certain aspects remote 508 is located in the vehicle and can be accessed by a person inside the vehicle, e.g., a driver or passenger, such that the person is shielded from traffic or other dangers outside of the vehicle. In other aspects the remote can be accessible to a person outside the vehicle as well. More than one remote can be provided to access the system controls from a variety of locations on or around the vehicle. Remote 508 can be mounted or can be a portable FOB. Receiver 502 can provide signals to controller 501 for operating release mechanism 504 and/or reel assembly 505, as well as other aspects of the system. Anchor release 504 is reversibly coupled to anchor 507. In certain aspect anchor 507 and release mechanism 504 are attached by mechanism 509. The release mechanism can be activated manually (directly) or by remote (indirectly via controller 501) 508. Upon activation anchor 507 is deployed, i.e. decoupled from the anchor mechanism 504. In certain aspects anchor 507 is coupled to light rope 506. In certain aspects light rope 506 is wound around reel 505 and is capable of winding an unwinding as need be, either manually or automatically via motors. Reel 505 can be connected to a motor for winding light rope 506 after use. In certain aspects reel 505 can be configured to passively allow light rope 506 to deploy when the system is activated. Power supply 503 provides the appropriate power to system components that are run on electricity, e.g., receiver 502, controller 501, anchor release 504, reel assembly 505. Power supply 503 can be configured to provide power to light rope 506 as well as any motors connected to reel assembly 505. In certain aspects controller 501, receiver 502, and power source 503 can be contained with a mounted structure and connected to anchor release 504 and reel assembly 505. In a further embodiment controller 501, receiver 502, power source 503, anchor release 504, and reel assembly 505 can be assembled on structure that can be mounted on a vehicle or other surface. Alternative surfaces include gate posts or other structures flanking a driveway, walkway, or other path. The system can be configured such that the light rope can be removeably placed across an opening to signal that access through the opening is closed.

1. A safety device comprising lighted elements arranged along a flexible device that is configured to be wound around and deployed from a reel, a first end of the flexible device being attached to the reel and the second end of the device being attached to an anchor.

2. The device of claim 1, wherein the lighted elements are light emitting diodes.

3. The device of claim 1, wherein at least a portion of the lighted elements are wired in parallel.

4. The device of claim 1, wherein the lighted elements are contained in a flexible tubing.

5. The device of claim 1, wherein the anchor is a metal or concrete anchor.

6. The device of claim 1, wherein the reel comprises a handle for turning the reel.

7. The device of claim 1, further comprising at least one sensor for detecting vehicles crossing over the device.

8. The device of claim 7, wherein the sensor is couple to an alarm.

9. The device of claim 1, wherein the reel is configured to be attached to vehicle.

10. The device of claim 1, wherein the vehicle is an emergency or construction vehicle.
